(19) United States
(12) Patent Application Publication
(10) Pub. No.: US 2026/0100005 A1
(43) Pub. Date: Apr. 9, 2026

(54) Real-time On-Device Extended Reality Content Creation With Knowledge Distillation

(71) Applicant: Meta Platforms Technologies, LLC, Menlo Park, CA (US)

(72) Inventors: Bina THAKKAR, Cary, NC (US); Andrew Kog Wah CHANG, Los Angeles, CA (US); Gabriel Benjamin Mark SHALOM, London (GB)

(21) Appl. No.: 19/268,145

(22) Filed: Jul. 14, 2025

Related U.S. Application Data
(60) Provisional application No. 63/703,837, filed on Oct. 4, 2024.

(51) Int. Cl. G06T 19/00; G06T 7/194; G06T 7/50; G06V 20/20; G06V 20/40; G11B 27/036

(52) U.S. Cl. CPC G06T 19/006; G06T 7/194; G06T 7/50; G06V 20/20; G06V 20/40; G11B 27/036; G06T 2207/10016

(57) ABSTRACT

A method for creating a produced XR video is described. The method includes, while a head-wearable device is worn by a user: (i) receiving video data from a camera of the head-wearable device, (ii) receiving at least one user input, the at least one user input indicating that the user wants to augment the video data with at least one virtual element at a user-selected position within a scene of the video data, (iii) based on the at least one user input, augmenting the video data by locating the at least one virtual element at the user-selected position to create a produced XR video, (iv) presenting the produced XR video to the user at a display of the head-wearable device, and (v) after the user provides an indication that the produced XR video is complete, causing the produced XR video to be sent from the head-wearable device to another device.

### CROSS-REFERENCE TO RELATED APPLICATIONS

This application claims priority to U.S. Provisional Ser. No. 63/703,837, titled “METHOD FOR REALTIME ON-DEVICE EXTENDED REALITY CONTENT CREATION WITH KNOWLEDGE DISTILLATION,” filed Oct. 4, 2024, which is herein incorporated by reference in its entirety.

### TECHNICAL FIELD

The present disclosure is directed to extended-reality (XR) content creation at a head-wearable device.

### BACKGROUND

Virtual production is a process for film production which utilizes game engines combined with LED volumes and camera tracking to create real-time, in-camera background parallax and various immersive lighting effects. Virtual production is costly, time consuming, and requires multiple technical experts to achieve results. Independent content creators have limited access to such virtual production techniques due to the high cost and required technical expertise. There is currently no consumer-priced hardware or software solution to empower individual or small creators to produce extended-reality (XR) content.

### BRIEF DESCRIPTION OF THE DRAWINGS

FIG. 1 illustrates a user creating extended-reality (XR) content at a head-wearable device, in accordance with some embodiments.

FIG. 2A illustrates a user editing video content at a head-wearable device, in accordance with some embodiments.

FIGS. 2B, 2C, 2D, and 2E illustrate a user adding virtual elements to video content at a head-wearable device, in accordance with some embodiments.

FIGS. 2F and 2G illustrate a user saving and sharing XR content at a head-wearable device, in accordance with some embodiments.

FIG. 3 illustrates a system for creating XR content at a head-wearable device, in accordance with some embodiments.

FIG. 4 illustrates a system for creating XR content at the head-wearable device, in accordance with some embodiments.

FIG. 5 shows an example flow chart for creating a produced XR video, in accordance with some embodiments.

FIGS. 6A, 6B, and 6C-1 and 6C-2 illustrate example MR and AR systems, in accordance with some embodiments.

FIG. 7 is a block diagram illustrating an overview of devices on which some implementations of the present technology can operate.

FIG. 8A is a wire diagram illustrating a virtual reality headset which can be used in some implementations of the present technology.

FIG. 8B is a wire diagram illustrating a mixed reality headset which can be used in some implementations of the present technology.

FIG. 8C is a wire diagram illustrating controllers which, in some implementations, a user can hold in one or both hands to interact with an extended reality environment.

FIG. 9 is a block diagram illustrating an overview of an environment in which some implementations of the present technology can operate.

The techniques introduced here may be better understood by referring to the following Detailed Description in conjunction with the accompanying drawings, in which like reference numerals indicate identical or functionally similar elements.

### DETAILED DESCRIPTION

One example method for creating a produced XR video is described herein. This example method occurs at a head-wearable device with at least a camera and display. In some embodiments, the example method includes, while the head-wearable device is worn by a user: (i) receiving video data from a camera of the head-wearable device, (ii) receiving at least one user input, the at least one user input indicating that the user wants to augment the video data with at least one virtual element at a user-selected position within a scene of the video data, (iii) based on the at least one user input, augmenting the video data by locating the at least one virtual element at the user-selected position to create a produced XR video, (iv) presenting the produced XR video to the user at a display of the head-wearable device, and (v) after the user provides an indication that the produced XR video is complete, causing the produced XR video to be sent from the head-wearable device to another device.

Another example method for creating a produced XR video at an XR headset is performed while the XR headset is worn by a user is also described. This example method comprises: (i) receiving video data from a camera of the XR headset, the video data showing a point-of-view of the user, (ii) receiving depth data from a depth sensor of the XR headset, the depth data indicating a distance between the user and at least one object in the video data, (iii) receiving at least one user input at the XR headset or an input device communicatively coupled to the XR headset, wherein the at least one user input indicates that the user wants to augment the video data with at least one virtual element at a user-selected position within a scene of the video data, (iv) based on the at least one user input and the depth data, augmenting the video data by locating the at least one virtual element at the user-selected position to create a produced XR video, (v) presenting the produced XR video to the user at a display of the XR headset, and (vi) after the user provides an indication that the produced XR video is complete, causing the produced XR video to be sent from the XR headset to another device associated with another user.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset (e.g., a mixed-reality (MR) headset, a virtual reality (VR) headset, or an augmented-reality (AR) headset), a wrist-wearable device, an intermediary processing device, a smart textile-based garment, etc. For instance, the instructions can be stored on an XR headset or can be stored on a combination of an XR headset and an associated input device (e.g., a wrist-wearable device) such that instructions for causing detection of input operations can be performed at the input device and instructions for causing changes to a displayed user interface in response to those input operations can be performed at the XR headset. The devices and systems described herein can be configured to be used in conjunction with methods and operations for providing an XR experience. The methods and operations for providing an XR experience can be stored on a non-transitory computer-readable storage medium.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Embodiments of the disclosed technology may include or be implemented in conjunction with an extended reality system. Extended reality, artificial reality, or extra reality (XR) is a form of reality that has been adjusted in some manner before presentation to a user, which may include, e.g., virtual reality (VR), augmented reality (AR), mixed reality (MR), hybrid reality, or some combination or derivatives thereof. Extended reality content may include completely generated content or generated content combined with captured content (e.g., real-world photographs). The extended reality content may include video, audio, haptic feedback, or some combination thereof, any of which may be presented in a single channel or in multiple channels (such as stereo video that produces a three-dimensional effect to the viewer). Additionally, in some embodiments, extended reality may be associated with applications, products, accessories, services, or some combination thereof, that are, e.g., used to create content in an extended reality or used in (e.g., perform activities in) an extended reality. The extended reality system that provides the extended reality content may be implemented on various platforms, including a head-mounted display (HMD) connected to a host computer system, a standalone HMD, a mobile device or computing system, a “cave” environment or other projection system, or any other hardware platform capable of providing extended reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Extended reality,” “Artificial reality,” “extra reality,” or “XR,” as used herein, refers to any of VR, AR, MR, or any combination or hybrid thereof.

An XR environment, as described herein, can include, but is not limited to, non-immersive, semi-immersive, and fully immersive VR environments. As also alluded to above, AR environments can include marker-based AR environments, markerless XR environments, location-based XR environments, and projection-based XR environments. The above descriptions are not exhaustive and any other environment that allows for intentional environmental lighting to pass through to the user would fall within the scope of an XR environment.

The XR content can include video, audio, haptic events, sensory events, or some combination thereof, any of which can be presented in a single channel or in multiple channels (such as stereo video that produces a three-dimensional effect to a viewer). Additionally, XR can also be associated with applications, products, accessories, services, or some combination thereof, which are used, for example, to create content in an XR environment or are otherwise used in (e.g., to perform activities in) XR environments.

Interacting with these XR environments described herein can occur using multiple different modalities and the resulting outputs can also occur across multiple different modalities. In one example XR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) or inertial measurement units (IMUs) of a wrist-wearable device, or one or more sensors included in a smart textile wearable device) or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel). The different hand gestures disclosed herein can be detected using image data or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user or other electronic devices in the user's possession (e.g., smartphones, laptops, imaging devices, intermediary devices, or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset or elsewhere to detect in-air or surface-contact gestures or inputs at an intermediary processing device (e.g., through physical input components (e.g., buttons and trackpads)). These different input modalities can be interchanged based on both desired user experiences, portability, or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

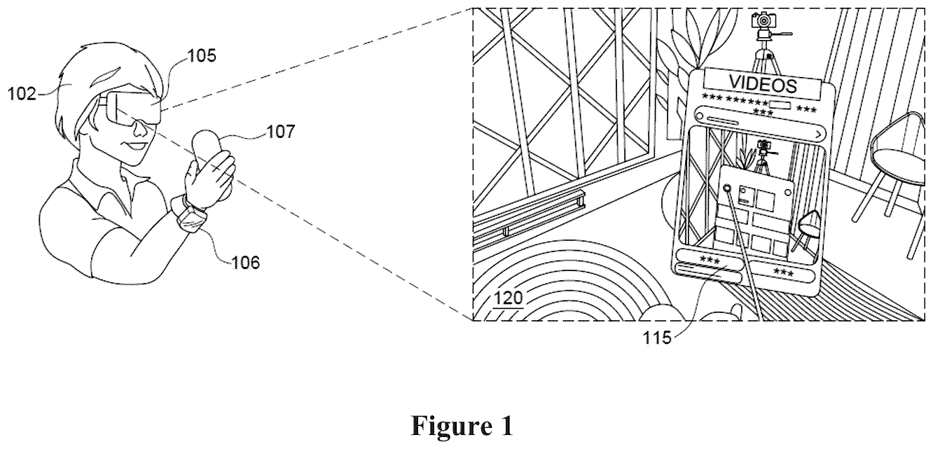

FIG. 1 illustrates a user 102 creating extended-reality (XR) content at a head-wearable device 105, in accordance with some embodiments. The head-wearable device 105 presents, via a display of the head-wearable device 105, a user interface 115 that the user 102 interacts with to create or edit a produced XR video 130. In some embodiments, the user 102 performs at least one user input to interact with the head-wearable device or the user interface 115. The at least one user input includes gaze inputs, detected by the head-wearable device 105, hand gestures, detected by a wrist-wearable device 106 communicatively coupled to the head-wearable device 105, or controller inputs, detected by at least one controller 107 communicatively coupled to the head-wearable device 105. In some embodiments, the head-wearable device 105 is an XR headset, a mixed-reality (MR) headset, an augmented-reality (AR) headset, or a virtual-reality (VR) headset. In some embodiments, the XR content is MR content, AR content, or VR content such as a video 120 or a picture with at least one virtual element added, as illustrated in FIG. 1. In some embodiments, the at least one virtual element includes a virtual background, a plurality of virtual objects, a virtual animation, or additional media. In some embodiments, the video 120 or picture is captured using a camera of the head-wearable device 105.

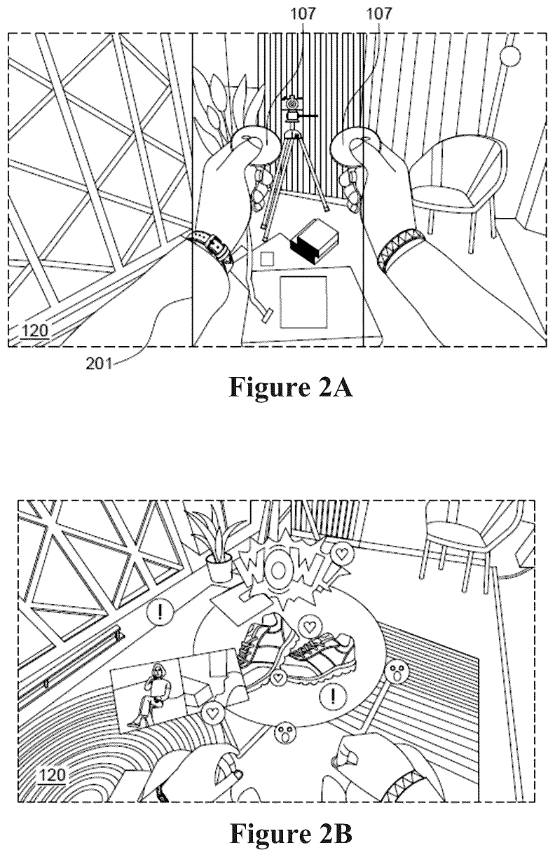

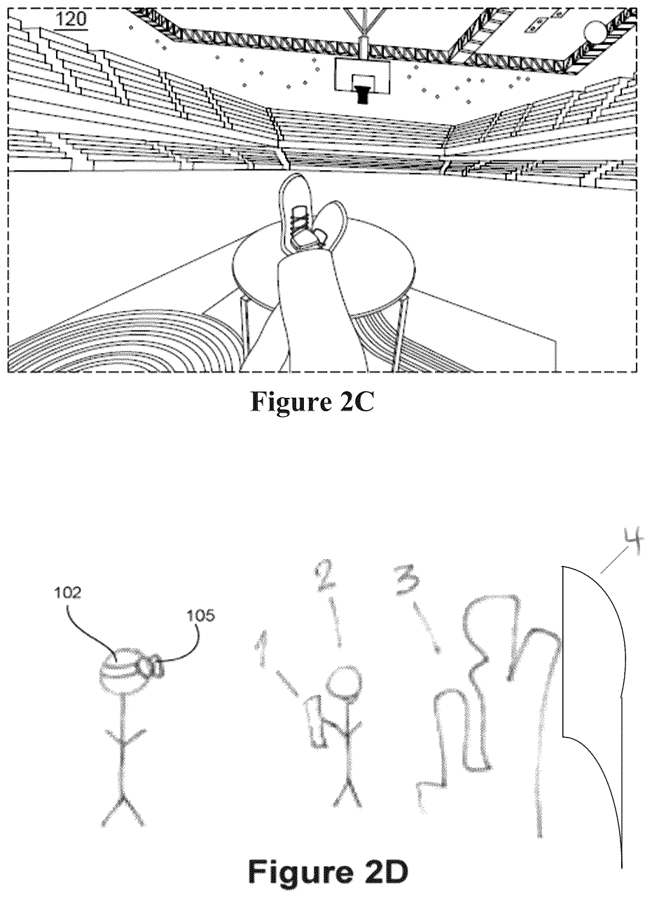

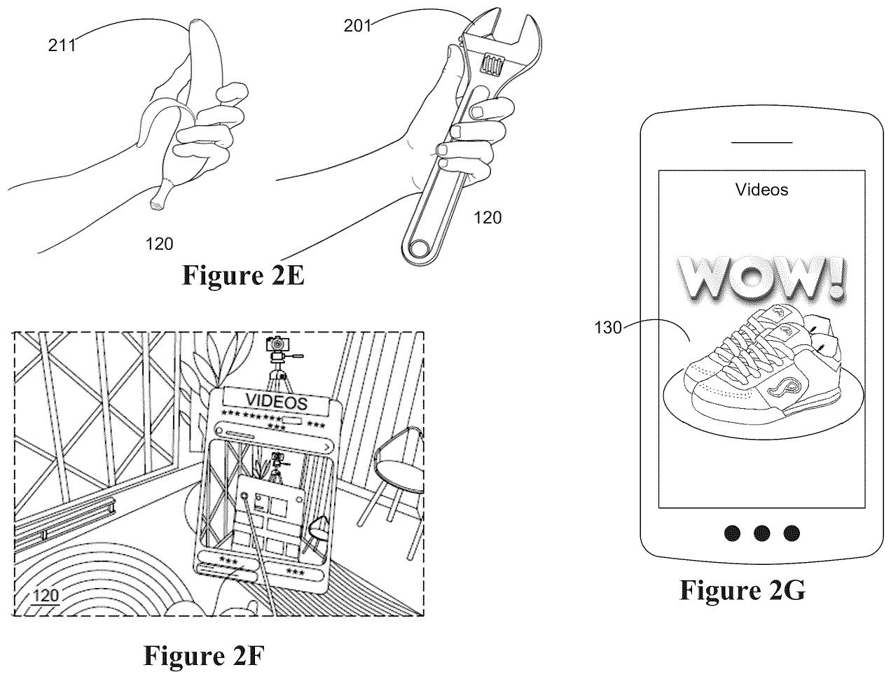

FIGS. 2A-2G illustrate the user 102 editing and augmenting the video 120 using the head-wearable device 105, in accordance with some embodiments. FIG. 2A illustrates the user 102 editing the video 120 using the head-wearable device 105, in accordance with some embodiments. In some embodiments, editing the video 120 or picture includes editing, changing, or modifying features of the video 120 and (e.g., cropping the video 120, as illustrated in FIG. 2A, trimming the video, applying a filter to the video, etc.) by interacting with the user interface 115. After editing the video 120, the edited video is presented to the user 105 at the display of the head-wearable device 105. For example, the user 105 performs a controller input (e.g., bringing two controllers together) to crop the video 120 to desired width, as illustrated in FIG. 2A. In some embodiments, the video 120 is a prerecorded video or a live video, as illustrated in FIG. 2A.

FIG. 2B illustrates the user 102 using the head-wearable device 105 to add virtual objects to the video 120, in accordance with some embodiments. In some embodiments, the virtual objects include virtual stickers, emojis, text, or additional media (e.g., pictures and other videos), as illustrated in FIG. 2B. For example, the user input (e.g., gaze direction, gesture, controller input, etc.) in three dimensions can be translated into a two-dimensional (or three-dimensional for 3D images or videos) location within the video or image and applied at the determined location as an overlay or by re-rendering the image or video to include the added virtual object. In some implementations, the location translation can include determining, from a user's perspective, where the focus of the inputs is in the image or video. This can include, for gaze input, determining where in the image or video the user's gaze is focused. In some cases, for gesture or controller input translating to location in the video or image can include determining where a line intersects the image or video where the line connects the user's eyes and a location identified for the gesture or controller. In some cases, for gesture or controller input translating to location in the video or image can include determining where a line intersects the image or video where the line is cast from the gesture or controller, with a pre-defined orientation to the gesture or controller posture. After adding the virtual objects to the video 120, the video with the virtual objects is presented to the user 105 at the display of the head-wearable device 105, as illustrated in FIG. 2B. As an example, the user 105 selects a plurality of virtual stickers from the user interface 115 and adds them to the video 120, as illustrated in FIG. 2B.

FIG. 2C illustrates the user 102 using the head-wearable device 105 to add a virtual background to the video 120, in accordance with some embodiments. The addition of the virtual background to the video 120 does not affect foreground objects captured in the video 120 (e.g., a table, a rug, legs of the user 102, etc.), as illustrated in FIG. 2C. In some embodiments, parallax is applied to the virtual background, based, at least, on depth information of objects detected in an environment surrounding the user 102. For example, the user 105 selects the virtual background from the user interface 115, and the video with the virtual background is presented to the user 105 at the display of the head-wearable device 105, as illustrated in FIG. 2C. In some embodiments, the depth information of the objects is detected by a sensor of the head-wearable device 105 or another sensor of a communicatively coupled device. In some embodiments, the virtual background and/or depth information for the video or image is generated by an artificial intelligence (AI) model. In some embodiments, another AI model is used to determine whether a physical object in the video 120 is a background object or a foreground object (e.g., such that background objects are replaced or covered by the virtual background and foreground objects remain in the video 120), which can include segmenting the image or video into areas according to identified objects and classifying each as being in the foreground or background. This can be accomplished using one or more AI models trained on training data that A) labels areas of images/video as being a discrete object or B) labels identified objects in an image or video or areas of images/video as being in a foreground or background. In some implementations, this labeling can be based on synthetic objects added to an image or video, depth data for a an image or video, related color and edge determinations in an image or video, or manual labeling of an image or video. FIG. 2D illustrates an example of a virtual background including virtual background 4 and foreground objects 1 and 2, where background objects 3 is to be not included in the video 120 once the virtual background 4 is added to the video 120.

FIG. 2E illustrates the user 102 using the head-wearable device 105 to add a replacement virtual object 201 to the video 120 such that it appears to replace a physical object 211 in the video, in accordance with some embodiments. After adding the replacement virtual object 210 to the video 120, the video with the replacement virtual object is presented to the user 105 at the display of the head-wearable device 105. As an example, the user 102 captures the video 120 including another person holding a banana 211 with the camera of the head-wearable device 105, the user 105 selects a representation of a wrench 201, and the representation of a wrench 201 is added to the video 120 such that it appears the hand of the other person, as illustrated in FIG. 2E. In some embodiments, the physical object 211, e.g., identifying the portion of the video that encompasses the contours of the physical object 211, is determined by an additional AI model, and the replacement virtual object 201 is generated and added to the video 120 by the additional AI model, e.g., appearing with occlusion by other objects in the video or image.

FIG. 2F illustrates the user 105 interacting with the user interface 115 to save a produced XR video 130 produced from editing the video 120 (e.g., as described in reference to FIG. 2A) or adding virtual elements to the video 120 (e.g., as described in reference to FIGS. 2B-2E), in accordance with some embodiments. The produced XR video 130 is saved to a storage device of the head-wearable device or a storage device communicatively coupled to the head-wearable device 105. In some embodiments, the user 102 shares the produced XR video 130 via integration with a social media application, a messaging application, or another media-sharing application. Another user may view the produced XR video 130 with the edits or added virtual elements at a device of the other user (e.g., another head-wearable device, a computer, a smartphone, as illustrated in FIG. 2G, etc.).

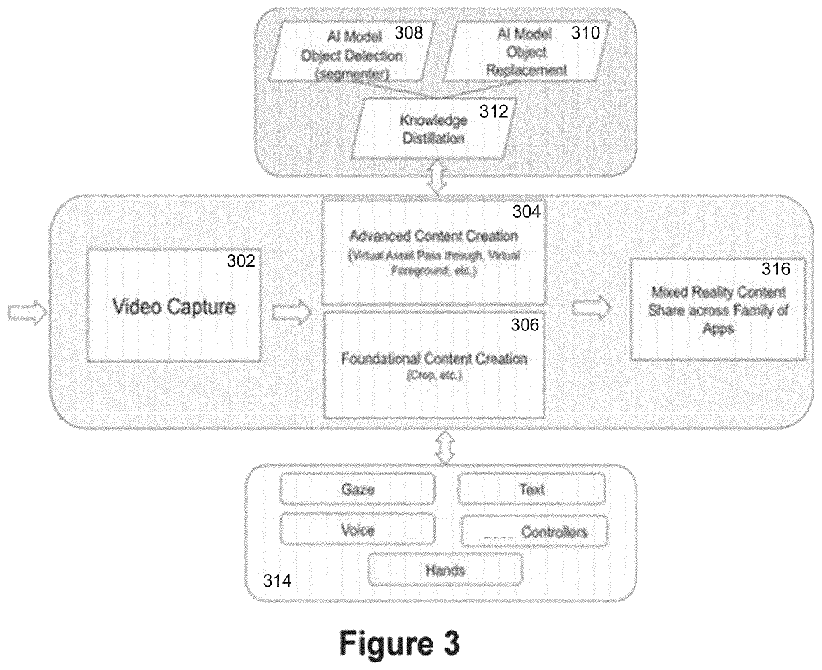

FIG. 3 illustrates an example diagram for creating the produced XR video 130 at the head-wearable device 105, in accordance with some embodiments. The head-wearable device 105 first captures, at 302, the video 120 from the camera of the head-wearable device 105 or, in some embodiments, receives, at 302, the video 120 from another communicatively coupled camera. The user 102 interacts with the head-wearable device 105 to create the produced XR video 130 with the video 120 (e.g., via the user interface 115 presented at the display of the head-wearable device 105). Creating the produced XR video 130 with the video 120 includes foundational content creation at 306 (e.g., cropping the video 120, trimming the video 120, applying a filter to the video 120, etc., as described in reference to FIG. 2A) or advanced content creation at 304 (e.g., adding virtual objects to the video 120, adding a virtual background to the video 120, adding a replacement virtual object to the video, etc., as described in reference to FIGS. 2B-2E). In some embodiments, the user 102 interacts with the head-wearable device 105, at 134, to create the produced XR video 130 by performing gaze inputs (e.g., gaze inputs detected by an eye-tracking camera of the head-wearable device 105), voice commands (e.g., voice commands detected by microphone of the head-wearable device 105), hand gestures (e.g., hand gestures detected by a biopotential sensor of the wrist-wearable device 106 communicatively coupled to the head-wearable device 105), text inputs (e.g., text inputs detected at a smartphone communicatively coupled to the head-wearable device 105), or controller inputs (e.g., controller inputs detected at one or more controllers communicatively coupled to the head-wearable device 105). In some embodiments, the advanced content creation 304 uses an object detection AI model 308 to detect, identify, or categorize physical objects in the video 120 (e.g., such as identifying the physical objects as background objects or foreground objects when adding a virtual background to the video 120). In some embodiments, the advanced content creation uses an object replacement AI model 310 to replace a physical object in the video 120 with a replacement virtual object (e.g., identifying the physical object in the video 120 and scaling a size of the replacement virtual object and placing the replacement virtual object in the video 120 such that the replacement virtual object appears to replace the physical object in the video 120). In some embodiments, the object detection AI model 308 or the object replacement AI model 310 are executed on a processing device communicatively coupled to the head-wearable device 105 (e.g., a server, a handheld intermediary processing device, a smartphone, etc.). In some implementations, the object detection AI model 308 or the object replacement AI model 310 can be controlled by, or their outputs can be filtered through, knowledge distillation 312. For example, knowledge distillation 312 can be an AI model or mapping that supplies prompts to object detection AI model 308 or the object replacement AI model 310, based on the user inputs. As another example, knowledge distillation 312 can be an AI model or mapping that receives output from object detection AI model 308 or the object replacement AI model 310, to translate the output into corresponding commands (e.g., image or video editing commands, API calls, coordinate transformations, etc.) defined in advanced content creation component 304. In some embodiments, the object detection AI model 308 or the object replacement AI model 310 are a student AI model that has been trained on a complex pretrained teacher model. The student AI model is configured to be executed at a processing device of the head-wearable device 105. After creating the produced XR video 130, the user 102 then chooses to share, at 316, the produced XR video 130 with the other user via the social media application, the messaging application, or the other media-sharing application.

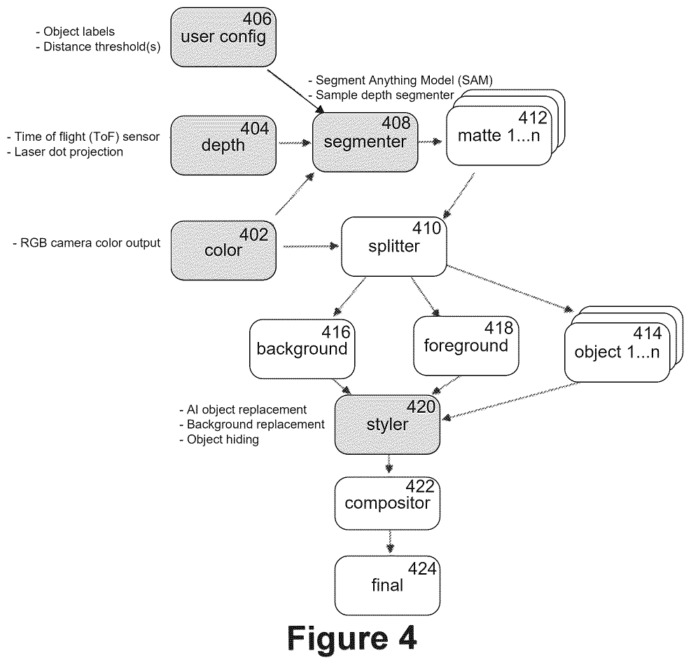

FIG. 4 illustrates an example system for creating the produced XR video 130 at the head-wearable device 105, in accordance with some embodiments. The system receives a color image data 402 (e.g., color image data from at least one RGB camera of the head-wearable device 105, such as the video 120), depth sensor data 404 (e.g., depth sensor data from a time-of-flight (ToF) sensor of the head-wearable device 105 or depth sensor data from a laser dot projector of the head-wearable device 105, or a depth map created from the depth sensor data from the ToF sensor or the depth sensor data from the laser dot projector), and user-configured settings 406 determined by the user 102 (e.g., user-generated or automatically-generated labels for physical objects based on the color image data or the depth sensor data, distance thresholds for determining mattes 412 (in some embodiments, a distance threshold may only apply to a certain region of the color image data, such as a lower third of the color image data, instead of the entirety of the color image data), etc.). At least the color image data 402, depth sensor data 404, and user-configured settings 406 are input into a segmenter 408 which segments the color image data 402 into a plurality of mattes 412 based on the depth sensor data 404 (e.g., each matte of the plurality of mattes includes a portion of the color image data associated with a distance (or depth) from the user 102 (or the camera of the head-wearable device 105)). In some embodiments, the segmenter 408 uses a segmenter AI model to produce the plurality of mattes 412. At least the plurality of mattes 412 and the color image data 402 are input into a splitter 410 which (i) identifies a plurality of physical objects 414 (e.g., objects 1-n) in the color image data 402 and (ii) splits the plurality of mattes 412 into background mattes 416 and foreground mattes 418. At least the plurality of physical objects 414, the background mattes 416, and the foreground mattes 418 are input into a styler 420 to the create or edit XR content using the color image data 402 (e.g., the video 120) as described in reference to FIGS. 2A-2E. For example, the user 102 chooses to add the virtual background to the color image data 402 (e.g., as described in reference to FIGS. 2C-2D), and the styler 420 replaces the background mattes 416 with the virtual background while the foreground mattes 418 remain in the produced XR video 130. As another example, the user 102 chooses to replace a selected object of the plurality of physical objects 414 with a selected virtual object (e.g., as described in reference to FIG. 2E), and the styler 420 replaces the selected object with the selected virtual object in the produced XR video 130 (424). The color image data 402 and virtual content added by the styler 420 (e.g., the virtual background, the selected virtual object, other virtual objects added by the user 102, etc.) are input into the compositor 422 which composites the color image data 402 and the virtual content into the produced XR video 130 (424). In some embodiments, the produced XR video 130 is presented to the user 102 at the display of the head-wearable device 105 or a display of another communicatively coupled device.

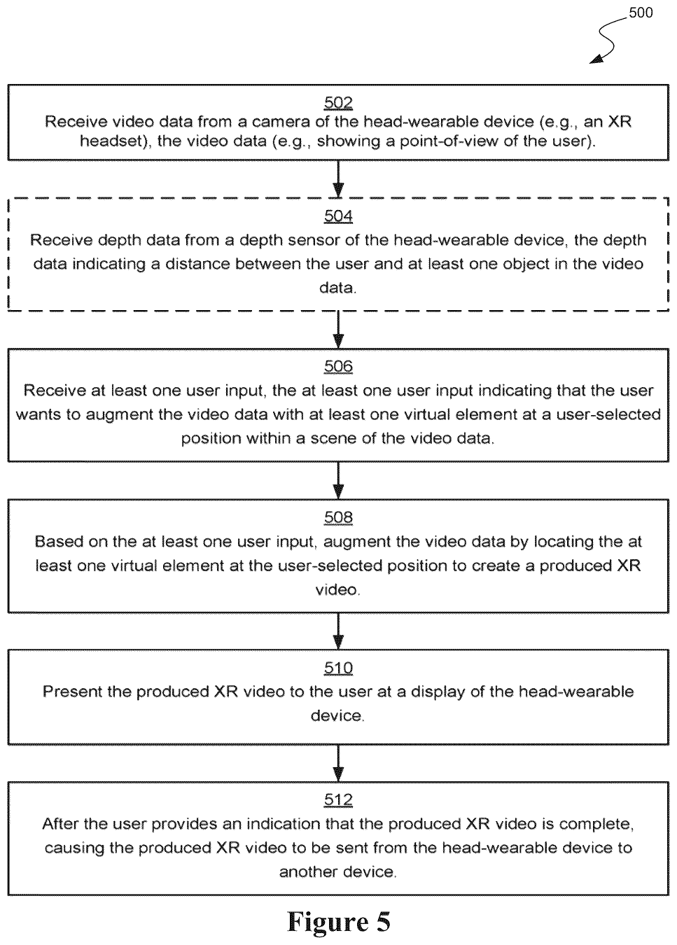

FIG. 5 illustrates a flow diagram of a method 500 of creating a produced XR video, in accordance with some embodiments. Operations (e.g., steps) of the method 500 can be performed by one or more processors (e.g., central processing unit or MCU) of a system for creating a produced XR video. At least some of the operations shown in FIG. 500 correspond to instructions stored in a computer memory or computer-readable storage medium (e.g., storage, RAM, or memory) for creating a produced XR video. Operations of the method 500 can be performed by a single device alone or in conjunction with one or more processors or hardware components of another communicatively coupled device (e.g., the head-wearable device 105) or instructions stored in memory or computer-readable medium of the other device communicatively coupled to the system. In some embodiments, the various operations of the methods described herein are interchangeable or optional, and respective operations of the methods are performed by any of the aforementioned devices, systems, or combination of devices or systems. For convenience, the method 500 operations will be described below as being performed by particular component or device but should not be construed as limiting the performance of the operation to the particular device in all embodiments.
(A1) FIG. 5 shows a flow chart of a method 500 for creating a produced XR video, in accordance with some embodiments. The method 500 can occur at the head-wearable device 105 with at least a camera and display or on a local or remote system in communication with such a device. In some embodiments, the method 500 includes, while a head-wearable device is worn by a user: (i) receiving video data from a camera of the head-wearable device 502, (ii) receiving at least one user input, the at least one user input indicating that the user wants to augment the video data with at least one virtual element at a user-selected position within a scene of the video data 506, (iii) based on the at least one user input, augmenting the video data by locating the at least one virtual element at the user-selected position to create a produced XR video 508, (iv) presenting the produced XR video to the user at a display of the head-wearable device 510, and (v) after the user provides an indication that the produced XR video is complete, causing the produced XR video to be sent from the head-wearable device to another device 512. In some embodiments, after receiving the video data from the camera of the head-wearable device, the method 500 also includes receiving depth data from a depth sensor of the XR headset, the depth data indicating a distance between the user and at least one object in the video data 504.
(B1) In accordance with some embodiments, another method for creating a produced XR video at an XR headset is performed while the XR headset is worn by a user. The other method comprises: (i) receiving video data from a camera of the XR headset, the video data showing a point-of-view of the user, (ii) receiving depth data from a depth sensor of the XR headset, the depth data indicating a distance between the user and at least one object in the video data, (iii) receiving at least one user input at the XR headset or an input device communicatively coupled to the XR headset, wherein the at least one user input indicates that the user wants to augment the video data with at least one virtual element at a user-selected position within a scene of the video data, (iv) based on the at least one user input and the depth data, augmenting the video data by locating the at least one virtual element at the user-selected position to create a produced XR video, (v) presenting the produced XR video to the user at a display of the XR headset, and (vi) after the user provides an indication that the produced XR video is complete, causing the produced XR video to be sent from the XR headset to another device associated with another user.
(C1) In accordance with some embodiments, a system that includes one or more wrist wearable devices and an artificial-reality headset, and the system is configured to perform operations corresponding to any of A1 or B1.
(D1) In accordance with some embodiments, a non-transitory computer readable storage medium including instructions that, when executed by a computing device in communication with an artificial-reality headset, cause the computer device to perform operations corresponding to any of A1 or B1.
(E1) In accordance with some embodiments, a method of operating an artificial reality headset, including operations that correspond to any of A1 or B1.

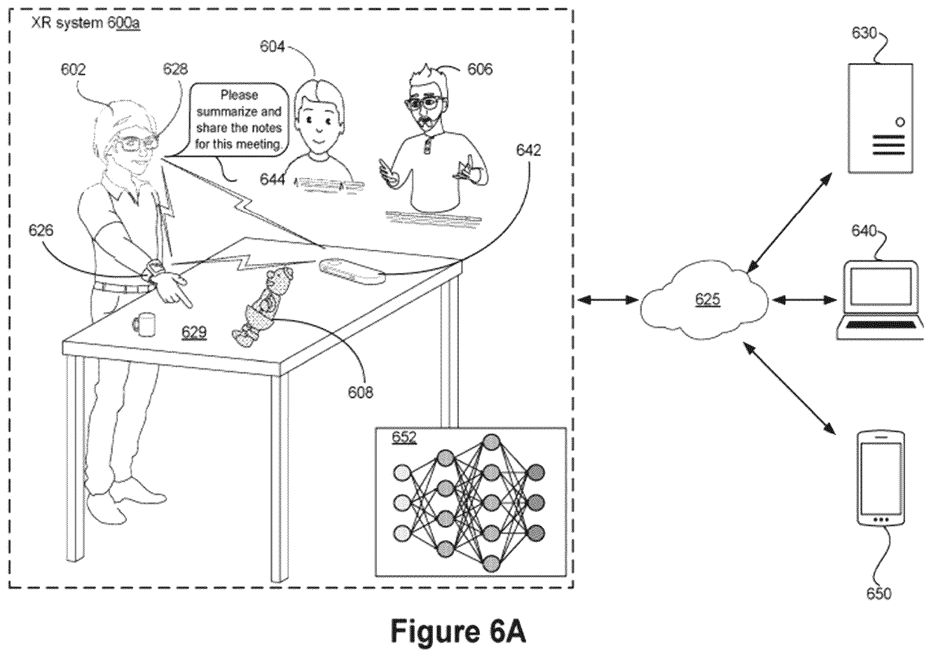

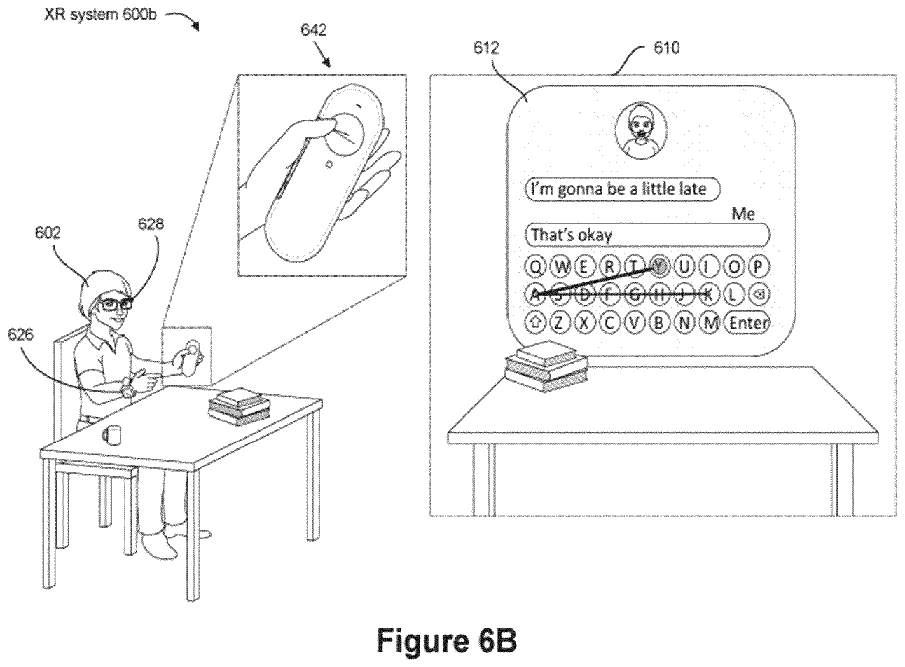

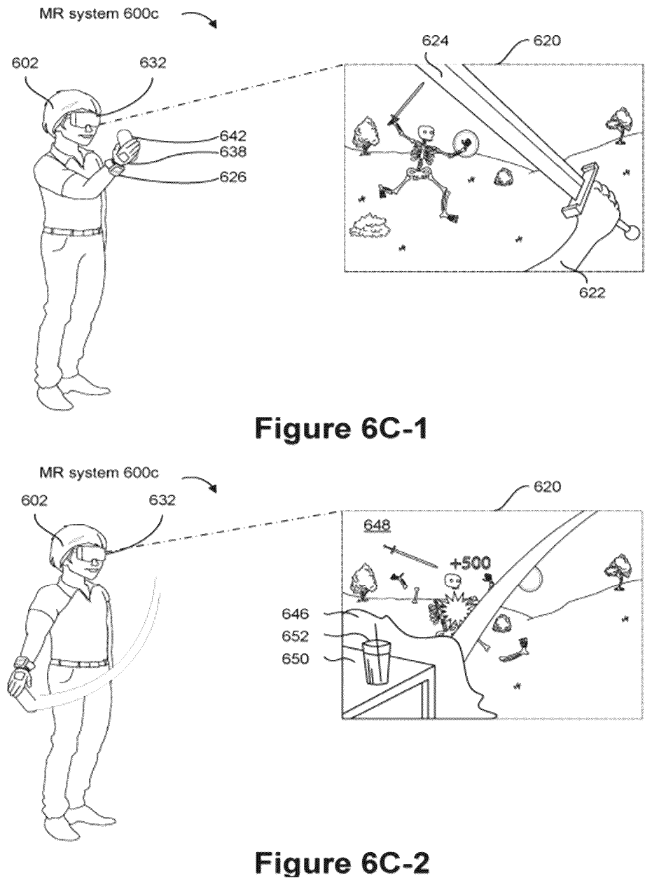

FIGS. 6A, 6B, and 6C-1 and 6C-2, illustrate example XR systems that include AR and MR systems, in accordance with some embodiments. FIG. 6A shows a first XR system 600a and first example user interactions using a wrist-wearable device 626, a head-wearable device (e.g., AR device 628), or a HIPD 642. FIG. 6B shows a second XR system 600b and second example user interactions using a wrist-wearable device 626, AR device 628, or an HIPD 642. FIGS. 6C-1 and 6C-2 show a third MR system 600c and third example user interactions using a wrist-wearable device 626, a head-wearable device (e.g., an MR device such as a VR device), or an HIPD 642. As the skilled artisan will appreciate upon reading the descriptions provided herein, the above-example AR and MR systems (described in detail below) can perform various functions or operations.

The wrist-wearable device 626, the head-wearable devices, or the HIPD 642 can communicatively couple via a network 625 (e.g., cellular, near field, Wi-Fi, personal area network, wireless LAN). Additionally, the wrist-wearable device 626, the head-wearable device, or the HIPD 642 can also communicatively couple with one or more servers 630, computers 640 (e.g., laptops, computers), mobile devices 650 (e.g., smartphones, tablets), or other electronic devices via the network 625 (e.g., cellular, near field, Wi-Fi, personal area network, wireless LAN). Similarly, a smart textile-based garment, when used, can also communicatively couple with the wrist-wearable device 626, the head-wearable device(s), the HIPD 642, the one or more servers 630, the computers 640, the mobile devices 650, or other electronic devices via the network 625 to provide inputs.

Turning to FIG. 6A, a user 602 is shown wearing the wrist-wearable device 626 and the AR device 628 and having the HIPD 642 on their desk. The wrist-wearable device 626, the AR device 628, and the HIPD 642 facilitate user interaction with an AR environment. In particular, as shown by the first AR system 600a, the wrist-wearable device 626, the AR device 628, or the HIPD 642 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 626, the AR device 628, or the HIPD 642. In addition, the user 602 is also able to directly view physical objects in the environment, such as a physical table 629, through transparent lens(es) and waveguide(s) of the AR device 628. Alternatively, an MR device could be used in place of the AR device 628 and a similar user experience can take place, but the user would not be directly viewing physical objects in the environment, such as table 629, and would instead be presented with a virtual reconstruction of the table 629 produced from one or more sensors of the MR device (e.g., an outward facing camera capable of recording the surrounding environment).

The user 602 can use any of the wrist-wearable device 626, the AR device 628 (e.g., through physical inputs at the AR device or built-in motion tracking of a user's extremities), a smart-textile garment, externally mounted extremity tracking device, the HIPD 642 to provide user inputs, etc. For example, the user 602 can perform one or more hand gestures that are detected by the wrist-wearable device 626 (e.g., using one or more EMG sensors or IMUs built into the wrist-wearable device) or AR device 628 (e.g., using one or more image sensors or cameras) to provide a user input. Alternatively, or additionally, the user 602 can provide a user input via one or more touch surfaces of the wrist-wearable device 626, the AR device 628, or the HIPD 642, or voice commands captured by a microphone of the wrist-wearable device 626, the AR device 628, or the HIPD 642. The wrist-wearable device 626, the AR device 628, or the HIPD 642 include an artificially intelligent digital assistant to help the user in providing a user input (e.g., completing a sequence of operations, suggesting different operations or commands, providing reminders, confirming a command). For example, the digital assistant can be invoked through an input occurring at the AR device 628 (e.g., via an input at a temple arm of the AR device 628). In some embodiments, the user 602 can provide a user input via one or more facial gestures or facial expressions. For example, cameras of the wrist-wearable device 626, the AR device 628, or the HIPD 642 can track the user 602's eyes for navigating a user interface.

The wrist-wearable device 626, the AR device 628, or the HIPD 642 can operate alone or in conjunction to allow the user 602 to interact with the AR environment. In some embodiments, the HIPD 642 is configured to operate as a central hub or control center for the wrist-wearable device 626, the AR device 628, or another communicatively coupled device. For example, the user 602 can provide an input to interact with the AR environment at any of the wrist-wearable device 626, the AR device 628, or the HIPD 642, and the HIPD 642 can identify one or more back-end and front-end tasks to cause the performance of the requested interaction and distribute instructions to cause the performance of the one or more back-end and front-end tasks at the wrist-wearable device 626, the AR device 628, or the HIPD 642. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 642 can perform the back-end tasks and provide the wrist-wearable device 626 or the AR device 628 operational data corresponding to the performed back-end tasks such that the wrist-wearable device 626 or the AR device 628 can perform the front-end tasks. In this way, the HIPD 642, which has more computational resources and greater thermal headroom than the wrist-wearable device 626 or the AR device 628, performs computationally intensive tasks and reduces the computer resource utilization or power usage of the wrist-wearable device 626 or the AR device 628.

In the example shown by the first AR system 600a, the HIPD 642 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 642 performs back-end tasks for processing or rendering image data (and other data) associated with the AR video call and provides operational data associated with the performed back-end tasks to the AR device 628 such that the AR device 628 performs front-end tasks for presenting the AR video call (e.g., presenting the avatar 604 and the digital representation of the contact 606).

In some embodiments, the HIPD 642 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 642. In particular, the HIPD 642 and the AR device 628 operate in conjunction to determine a location for presenting the avatar 604 and the digital representation of the contact 606. In some embodiments, information can be presented within a predetermined distance from the HIPD 642 (e.g., within five meters). For example, as shown in the first AR system 600a, virtual object 608 is presented on the desk some distance from the HIPD 642. Similar to the above example, the HIPD 642 and the AR device 628 can operate in conjunction to determine a location for presenting the virtual object 608. Alternatively, in some embodiments, presentation of information is not bound by the HIPD 642. More specifically, the avatar 604, the digital representation of the contact 606, and the virtual object 608 do not have to be presented within a predetermined distance of the HIPD 642. While an AR device 628 is described working with an HIPD, an MR headset can be interacted with in the same way as the AR device 628.

User inputs provided at the wrist-wearable device 626, the AR device 628, or the HIPD 642 are coordinated such that the user can use any device to initiate, continue, or complete an operation. For example, the user 602 can provide a user input to the AR device 628 to cause the AR device 628 to present the virtual object 608 and, while the virtual object 608 is presented by the AR device 628, the user 602 can provide one or more hand gestures via the wrist-wearable device 626 to interact or manipulate the virtual object 608. While an AR device 628 is described working with a wrist-wearable device 626, an MR headset can be interacted with in the same way as the AR device 628.

FIG. 6A illustrates an interaction in which an artificially intelligent virtual assistant can assist in requests made by a user 602. The AI virtual assistant can be used to complete open-ended requests made through natural language inputs by a user 602. For example, in FIG. 6A the user 602 makes an audible request 644 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 6A also illustrates an example neural network 652 used in Artificial Intelligence applications. Uses of Artificial Intelligence (AI) are varied and encompass many different aspects of the devices and systems described herein. AI capabilities cover a diverse range of applications and deepen interactions between the user 602 and user devices (e.g., the AR device 628, an MR device 632, the HIPD 642, the wrist-wearable device 626). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 602 can interact with an AI model through natural language inputs captured by a voice sensor, text inputs, or any other input modality that accepts natural language or a corresponding voice sensor module. In another instance, input is provided by tracking the eye gaze of a user 602 via a gaze tracker module. Additionally, the AI model can also receive inputs beyond those supplied by a user 602. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors or their corresponding sensor modules. The sensors' data can be retrieved entirely from a single device (e.g., AR device 628) or from multiple devices that are in communication with each other (e.g., a system that includes at least two of an AR device 628, an MR device 632, the HIPD 642, the wrist-wearable device 626, etc.). The AI model can also access additional information (e.g., one or more servers 630, the computers 640, the mobile devices 650, or other electronic devices) via a network 625.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 628, an MR device 632, the HIPD 642, the wrist-wearable device 626) via the one or more networks. The cloud-computing platforms provide scalable computing resources, distributed computing, managed AI services, interference acceleration, pre-trained models, APIs or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 628, an MR device 632, the HIPD 642, the wrist-wearable device 626), storage options of the external devices (servers, computers, mobile devices, etc.), or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 642), haptic feedback can provide information to the user 602. An AI model can also use the inputs described above to determine the appropriate modality and device(s) to present content to the user (e.g., a user walking on a busy road can be presented with an audio output instead of a visual output to avoid distracting the user 602).

FIG. 6B shows the user 602 wearing the wrist-wearable device 626 and the AR device 628 and holding the HIPD 642. In the second AR system 600b, the wrist-wearable device 626, the AR device 628, or the HIPD 642 are used to receive or provide one or more messages to a contact of the user 602. In particular, the wrist-wearable device 626, the AR device 628, or the HIPD 642 detect and coordinate one or more user inputs to initiate a messaging application and prepare a response to a received message via the messaging application.

In some embodiments, the user 602 initiates, via a user input, an application on the wrist-wearable device 626, the AR device 628, or the HIPD 642 that causes the application to initiate on at least one device. For example, in the second AR system 600b the user 602 performs a hand gesture associated with a command for initiating a messaging application (represented by messaging user interface 612); the wrist-wearable device 626 detects the hand gesture; and, based on a determination that the user 602 is wearing the AR device 628, causes the AR device 628 to present a messaging user interface 612 of the messaging application. The AR device 628 can present the messaging user interface 612 to the user 602 via its display (e.g., as shown by user 602's field of view 610). In some embodiments, the application is initiated and can be run on the device (e.g., the wrist-wearable device 626, the AR device 628, or the HIPD 642) that detects the user input to initiate the application, and the device provides another device operational data to cause the presentation of the messaging application. For example, the wrist-wearable device 626 can detect the user input to initiate a messaging application, initiate and run the messaging application, and provide operational data to the AR device 628 or the HIPD 642 to cause presentation of the messaging application. Alternatively, the application can be initiated and run at a device other than the device that detected the user input. For example, the wrist-wearable device 626 can detect the hand gesture associated with initiating the messaging application and cause the HIPD 642 to run the messaging application and coordinate the presentation of the messaging application.

Further, the user 602 can provide a user input provided at the wrist-wearable device 626, the AR device 628, or the HIPD 642 to continue or complete an operation initiated at another device. For example, after initiating the messaging application via the wrist-wearable device 626 and while the AR device 628 presents the messaging user interface 612, the user 602 can provide an input at the HIPD 642 to prepare a response (e.g., shown by the swipe gesture performed on the HIPD 642). The user 602's gestures performed on the HIPD 642 can be provided or displayed on another device. For example, the user 602's swipe gestures performed on the HIPD 642 are displayed on a virtual keyboard of the messaging user interface 612 displayed by the AR device 628.

In some embodiments, the wrist-wearable device 626, the AR device 628, the HIPD 642, or other communicatively coupled devices can present one or more notifications to the user 602. The notification can be an indication of a new message, an incoming call, an application update, a status update, etc. The user 602 can select the notification via the wrist-wearable device 626, the AR device 628, or the HIPD 642 and cause presentation of an application or operation associated with the notification on at least one device. For example, the user 602 can receive a notification that a message was received at the wrist-wearable device 626, the AR device 628, the HIPD 642, or other communicatively coupled device and provide a user input at the wrist-wearable device 626, the AR device 628, or the HIPD 642 to review the notification, and the device detecting the user input can cause an application associated with the notification to be initiated or presented at the wrist-wearable device 626, the AR device 628, or the HIPD 642.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 628 can present to the user 602 game application data and the HIPD 642 can use a controller to provide inputs to the game. Similarly, the user 602 can use the wrist-wearable device 626 to initiate a camera of the AR device 628, and the user can use the wrist-wearable device 626, the AR device 628, or the HIPD 642 to manipulate the image capture (e.g., zoom in or out, apply filters) and capture image data.

While an AR device 628 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

Turning to FIGS. 6C-1 and 6C-2, the user 602 is shown wearing the wrist-wearable device 626 and an MR device 632 (e.g., a device capable of providing either an entirely VR experience or an MR experience that displays object(s) from a physical environment at a display of the device) and holding the HIPD 642. In the third AR system 600c, the wrist-wearable device 626, the MR device 632, or the HIPD 642 are used to interact within an MR environment, such as a VR game or other MR/VR application. While the MR device 632 presents a representation of a VR game (e.g., first MR game environment 620) to the user 602, the wrist-wearable device 626, the MR device 632, or the HIPD 642 detect and coordinate one or more user inputs to allow the user 602 to interact with the VR game.

In some embodiments, the user 602 can provide a user input via the wrist-wearable device 626, the MR device 632, or the HIPD 642 that causes an action in a corresponding MR environment. For example, the user 602 in the third MR system 600c (shown in FIG. 6C-1) raises the HIPD 642 to prepare for a swing in the first MR game environment 620. The MR device 632, responsive to the user 602 raising the HIPD 642, causes the MR representation of the user 622 to perform a similar action (e.g., raise a virtual object, such as a virtual sword 624). In some embodiments, each device uses respective sensor data or image data to detect the user input and provide an accurate representation of the user 602's motion. For example, image sensors (e.g., SLAM cameras or other cameras) of the HIPD 642 can be used to detect a position of the HIPD 642 relative to the user 602's body such that the virtual object can be positioned appropriately within the first MR game environment 620; sensor data from the wrist-wearable device 626 can be used to detect a velocity at which the user 602 raises the HIPD 642 such that the MR representation of the user 622 and the virtual sword 624 are synchronized with the user 602's movements; and image sensors of the MR device 632 can be used to represent the user 602's body, boundary conditions, or real-world objects within the first MR game environment 620.

In FIG. 6C-2, the user 602 performs a downward swing while holding the HIPD 642. The user 602's downward swing is detected by the wrist-wearable device 626, the MR device 632, or the HIPD 642 and a corresponding action is performed in the first MR game environment 620. In some embodiments, the data captured by each device is used to improve the user's experience within the MR environment. For example, sensor data of the wrist-wearable device 626 can be used to determine a speed or force at which the downward swing is performed and image sensors of the HIPD 642 or the MR device 632 can be used to determine a location of the swing and how it should be represented in the first MR game environment 620, which, in turn, can be used as inputs for the MR environment (e.g., game mechanics, which can use detected speed, force, locations, or aspects of the user 602's actions to classify a user's inputs (e.g., user performs a light strike, hard strike, critical strike, glancing strike, miss) or calculate an output (e.g., amount of damage)).

FIG. 6C-2 further illustrates that a portion of the physical environment is reconstructed and displayed at a display of the MR device 632 while the MR game environment 620 is being displayed. In this instance, a reconstruction of the physical environment 646 is displayed in place of a portion of the MR game environment 620 when object(s) in the physical environment are potentially in the path of the user (e.g., a collision with the user and an object in the physical environment are likely). Thus, this example MR game environment 620 includes (i) an immersive VR portion 648 (e.g., an environment that does not have a corollary counterpart in a nearby physical environment) and (ii) a reconstruction of the physical environment 646 (e.g., table 650 and cup 652). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 626, the MR device 632, or the HIPD 642 are described as detecting user inputs, in some embodiments, user inputs are detected at a single device (with the single device being responsible for distributing signals to the other devices for performing the user input). For example, the HIPD 642 can operate an application for generating the first MR game environment 620 and provide the MR device 632 with corresponding data for causing the presentation of the first MR game environment 620, as well as detect the user 602's movements (while holding the HIPD 642) to cause the performance of corresponding actions within the first MR game environment 620. Additionally or alternatively, in some embodiments, operational data (e.g., sensor data, image data, application data, device data, or other data) of one or more devices is provided to a single device (e.g., the HIPD 642) to process the operational data and cause respective devices to perform an action associated with processed operational data.

In some embodiments, the user 602 can wear a wrist-wearable device 626, wear an MR device 632, wear smart textile-based garments 638 (e.g., wearable haptic gloves), or hold an HIPD 642 device. In this embodiment, the wrist-wearable device 626, the MR device 632, or the smart textile-based garments 638 are used to interact within an MR environment (e.g., any AR or MR system described above in reference to FIG. 6A-6B). While the MR device 632 presents a representation of an MR game (e.g., second MR game environment 620) to the user 602, the wrist-wearable device 626, the MR device 632, or the smart textile-based garments 638 detect and coordinate one or more user inputs to allow the user 602 to interact with the MR environment.

In some embodiments, the user 602 can provide a user input via the wrist-wearable device 626, an HIPD 642, the MR device 632, or the smart textile-based garments 638 that causes an action in a corresponding MR environment. In some embodiments, each device uses respective sensor data or image data to detect the user input and provide an accurate representation of the user 602's motion. While four different input devices are shown (e.g., a wrist-wearable device 626, an MR device 632, an HIPD 642, and a smart textile-based garment 638) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 638) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 638 can be used in conjunction with an MR device or an HIPD 642.

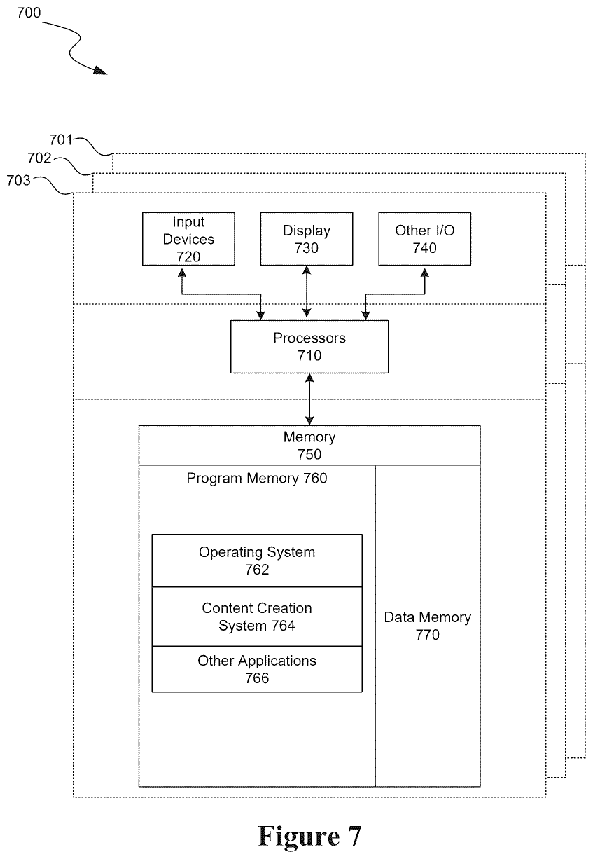

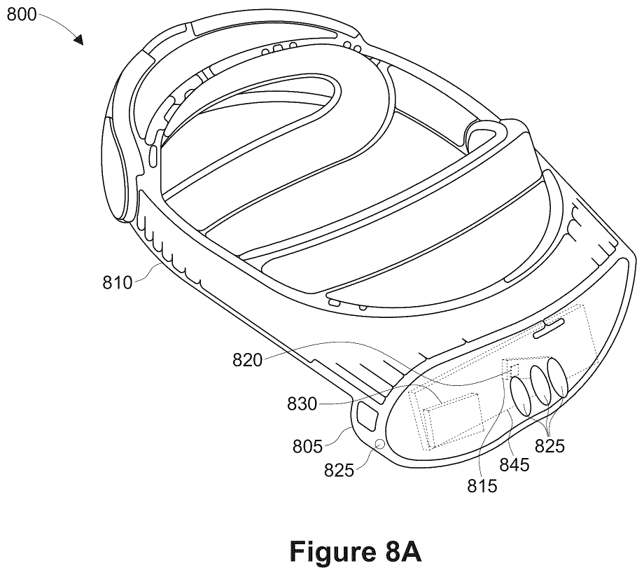

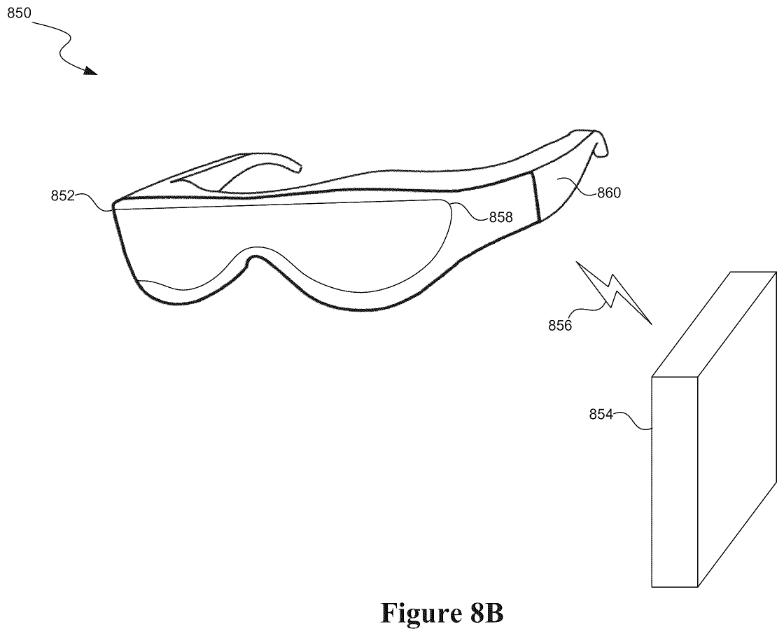

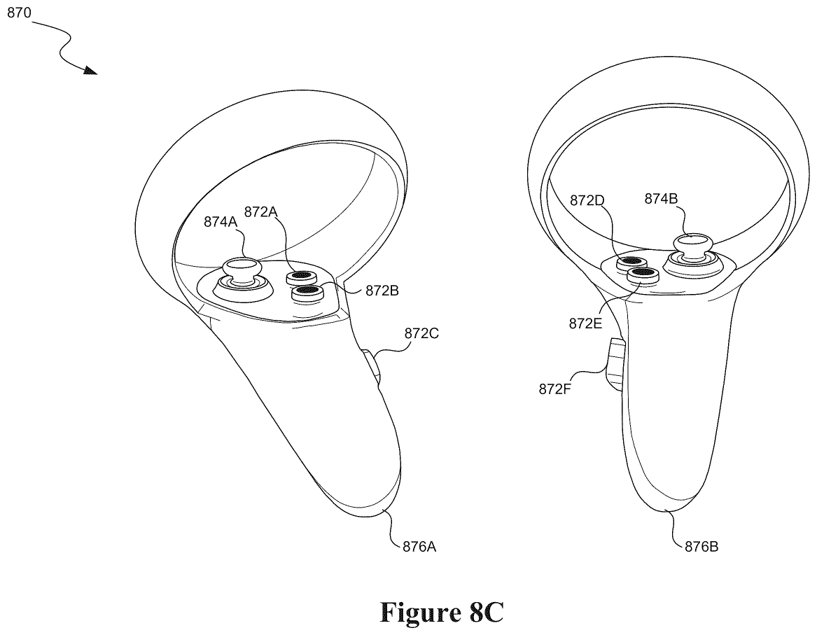

Several implementations are discussed below in more detail in reference to the figures. FIG. 7 is a block diagram illustrating an overview of devices on which some implementations of the disclosed technology can operate. The devices can comprise hardware components of a computing system 700 that can modify and generate content on an XR system according to user commands. In various implementations, computing system 700 can include a single computing device 703 or multiple computing devices (e.g., computing device 701, computing device 702, and computing device 703) that communicate over wired or wireless channels to distribute processing and share input data. In some implementations, computing system 700 can include a stand-alone headset capable of providing a computer created or augmented experience for a user without the need for external processing or sensors. In other implementations, computing system 700 can include multiple computing devices such as a headset and a core processing component (such as a console, mobile device, or server system) where some processing operations are performed on the headset and others are offloaded to the core processing component. Example headsets are described below in relation to FIGS. 8A and 8B. In some implementations, position and environment data can be gathered only by sensors incorporated in the headset device, while in other implementations one or more of the non-headset computing devices can include sensor components that can track environment or position data.

Computing system 700 can include one or more processor(s) 710 (e.g., central processing units (CPUs), graphical processing units (GPUs), holographic processing units (HPUs), etc.) Processors 710 can be a single processing unit or multiple processing units in a device or distributed across multiple devices (e.g., distributed across two or more of computing devices 701-703).

Computing system 700 can include one or more input devices 720 that provide input to the processors 710, notifying them of actions. The actions can be mediated by a hardware controller that interprets the signals received from the input device and communicates the information to the processors 710 using a communication protocol. Each input device 720 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 710 can be coupled to other hardware devices, for example, with the use of an internal or external bus, such as a PCI bus, SCSI bus, or wireless connection. The processors 710 can communicate with a hardware controller for devices, such as for a display 730. Display 730 can be used to display text and graphics. In some implementations, display 730 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 740 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 740, such as cameras, depth sensors, IMU sensor, GPS units, LiDAR or other time-of-flights sensors, etc. can be used by the computing system 700 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 700 or another computing system that had mapped the area. The SLAM system can track the user within the area based on factors such as GPS data, matching identified objects and structures to mapped objects and structures, monitoring acceleration and other position changes, etc.

Computing system 700 can include a communication device capable of communicating wirelessly or wire-based with other local computing devices or a network node. The communication device can communicate with another device or a server through a network using, for example, TCP/IP protocols. Computing system 700 can utilize the communication device to distribute operations across multiple network devices.

The processors 710 can have access to a memory 750, which can be contained on one of the computing devices of computing system 700 or can be distributed across of the multiple computing devices of computing system 700 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 750 can include program memory 760 that stores programs and software, such as an operating system 762, content creation system 764, and other application programs 766. Memory 750 can also include data memory 770, configuration data, settings, user options or preferences, etc., which can be provided to the program memory 760 or any element of the computing system 700.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to steps as shown and described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 8A is a wire diagram of a virtual reality head-mounted display (HMD) 800, in accordance with some embodiments. In this example, HMD 800 also includes augmented reality features, using passthrough cameras 825 to render portions of the real world, which can have computer generated overlays. The HMD 800 includes a front rigid body 805 and a band 810. The front rigid body 805 includes one or more electronic display elements of one or more electronic displays 845, an inertial motion unit (IMU) 815, one or more position sensors 820, cameras and locators 825, and one or more compute units 830. The position sensors 820, the IMU 815, and compute units 830 may be internal to the HMD 800 and may not be visible to the user. In various implementations, the IMU 815, position sensors 820, and cameras and locators 825 can track movement and location of the HMD 800 in the real world and in an extended reality environment in three degrees of freedom (3DoF) or six degrees of freedom (6DoF). For example, locators 825 can emit infrared light beams which create light points on real objects around the HMD 800 and/or cameras 825 capture images of the real world and localize the HMD 800 within that real world environment. As another example, the IMU 815 can include e.g., one or more accelerometers, gyroscopes, magnetometers, other non-camera-based position, force, or orientation sensors, or combinations thereof, which can be used in the localization process. One or more cameras 825 integrated with the HMD 800 can detect the light points. Compute units 830 in the HMD 800 can use the detected light points and/or location points to extrapolate position and movement of the HMD 800 as well as to identify the shape and position of the real objects surrounding the HMD 800.

The electronic display(s) 845 can be integrated with the front rigid body 805 and can provide image light to a user as dictated by the compute units 830. In various embodiments, the electronic display 845 can be a single electronic display or multiple electronic displays (e.g., a display for each user eye). Examples of the electronic display 845 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 800 can be coupled to a core processing component such as a personal computer (PC) (not shown) and/or one or more external sensors (not shown). The external sensors can monitor the HMD 800 (e.g., via light emitted from the HMD 800) which the PC can use, in combination with output from the IMU 815 and position sensors 820, to determine the location and movement of the HMD 800.

FIG. 8B is a wire diagram of a mixed reality HMD system 850 which includes a mixed reality HMD 852 and a core processing component 854. The mixed reality HMD 852 and the core processing component 854 can communicate via a wireless connection (e.g., a 60 GHz link) as indicated by link 856. In other implementations, the mixed reality system 850 includes a headset only, without an external compute device or includes other wired or wireless connections between the mixed reality HMD 852 and the core processing component 854. The mixed reality HMD 852 includes a pass-through display 858 and a frame 860. The frame 860 can house various electronic components (not shown) such as light projectors (e.g., LASERs, LEDs, etc.), cameras, eye-tracking sensors, MEMS components, networking components, etc.

The projectors can be coupled to the pass-through display 858, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 854 via link 856 to HMD 852. Controllers in the HMD 852 can convert the image data into light pulses from the projectors, which can be transmitted via the optical elements as output light to the user's eye. The output light can mix with light that passes through the display 858, allowing the output light to present virtual objects that appear as if they exist in the real world.

Similarly to the HMD 800, the HMD system 850 can also include motion and position tracking units, cameras, light sources, etc., which allow the HMD system 850 to, e.g., track itself in 3DoF or 6DoF, track portions of the user (e.g., hands, feet, head, or other body parts), map virtual objects to appear as stationary as the HMD 852 moves, and have virtual objects react to gestures and other real-world objects.

FIG. 8C illustrates controllers 870 (including controller 876A and 876B), which, in some implementations, a user can hold in one or both hands to interact with an extended reality environment presented by the HMD 800 and/or HMD 850. The controllers 870 can be in communication with the HMDs, either directly or via an external device (e.g., core processing component 854). The controllers can have their own IMU units, position sensors, and/or can emit further light points. The HMD 800 or 850, external sensors, or sensors in the controllers can track these controller light points to determine the controller positions and/or orientations (e.g., to track the controllers in 3DoF or 6DoF). The compute units 830 in the HMD 800 or the core processing component 854 can use this tracking, in combination with IMU and position output, to monitor hand positions and motions of the user. The controllers can also include various buttons (e.g., buttons 872A-F) and/or joysticks (e.g., joysticks 874A-B), which a user can actuate to provide input and interact with objects.

In various implementations, the HMD 800 or 850 can also include additional subsystems, such as an eye tracking unit, an audio system, various network components, etc., to monitor indications of user interactions and intentions. For example, in some implementations, instead of or in addition to controllers, one or more cameras included in the HMD 800 or 850, or from external cameras, can monitor the positions and poses of the user's hands to determine gestures and other hand and body motions. As another example, one or more light sources can illuminate either or both of the user's eyes and the HMD 800 or 850 can use eye-facing cameras to capture a reflection of this light to determine eye position (e.g., based on set of reflections around the user's cornea), modeling the user's eye and determining a gaze direction.

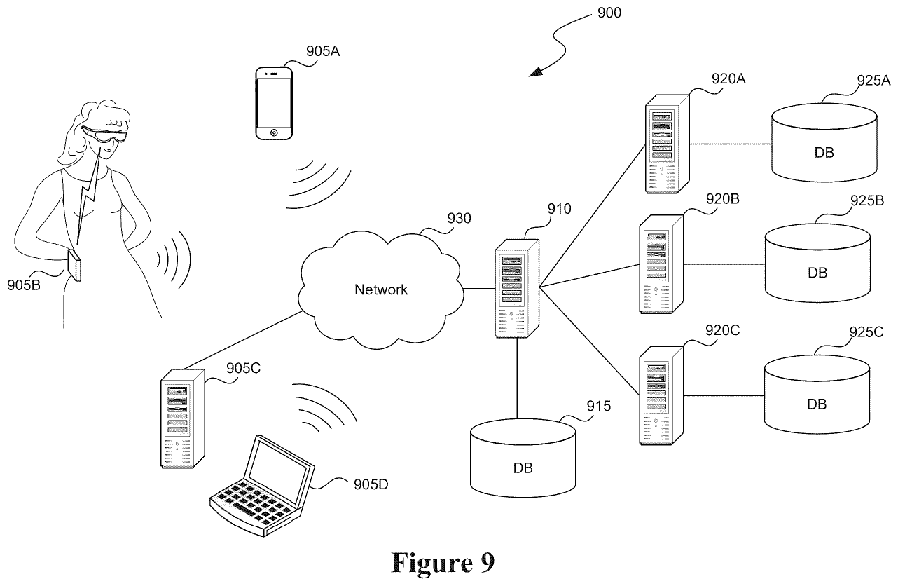

FIG. 9 is a block diagram illustrating an overview of an environment 900 in which some implementations of the disclosed technology can operate. Environment 900 can include one or more client computing devices 905A-D, examples of which can include computing system 700. In some implementations, some of the client computing devices (e.g., client computing device 905B) can be the HMD 800 or the HMD system 850. Client computing devices 905 can operate in a networked environment using logical connections through network 930 to one or more remote computers, such as a server computing device.

In some implementations, server 910 can be an edge server which receives client requests and coordinates fulfillment of those requests through other servers, such as servers 920A-C. Server computing devices 910 and 920 can comprise computing systems, such as computing system 700. Though each server computing device 910 and 920 is displayed logically as a single server, server computing devices can each be a distributed computing environment encompassing multiple computing devices located at the same or at geographically disparate physical locations.

Client computing devices 905 and server computing devices 910 and 920 can each act as a server or client to other server/client device(s). Server 910 can connect to a database 915. Servers 920A-C can each connect to a corresponding database 925A-C. As discussed above, each server 910 or 920 can correspond to a group of servers, and each of these servers can share a database or can have their own database. Though databases 915 and 925 are displayed logically as single units, databases 915 and 925 can each be a distributed computing environment encompassing multiple computing devices, can be located within their corresponding server, or can be located at the same or at geographically disparate physical locations.

Network 930 can be a local area network (LAN), a wide area network (WAN), a mesh network, a hybrid network, or other wired or wireless networks. Network 930 may be the Internet or some other public or private network. Client computing devices 905 can be connected to network 930 through a network interface, such as by wired or wireless communication. While the connections between server 910 and servers 920 are shown as separate connections, these connections can be any kind of local, wide area, wired, or wireless network, including network 930 or a separate public or private network.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for creating a produced extended-reality (XR) video at an XR headset, the method comprising:
receiving video data from a camera of the XR headset, the video data showing a point-of-view of the user;
receiving depth data indicating a distance between the user and at least one object in the video data;
receiving a first user input, at the XR headset and/or an input device communicatively coupled to the XR headset, that indicates a user intent to augment the video data with at least one virtual element at a user-selected position within a scene of the video data;
based on the first user input and the depth data, augmenting the video data by locating the at least one virtual element at the user-selected position to create the produced XR video;
presenting the produced XR video to the user via a display of the XR headset; and
causing the produced XR video to be sent, from the XR headset, to another device associated with another user.

2. The method of claim 1, wherein the depth data is from a depth sensor of the XR headset.

3. The method of claim 1, wherein the depth data is generated by an artificial reality model trained to produce depth data for image data received by the artificial reality model.

4. The method of claim 1 further comprising:
receiving a second user input, as motion in a 3D environment, that indicates a user intent to crop a video that the video data represents, trim the video that the video data represents, apply a filter to the video that the video data represents, or any combination thereof;
translating the motion in the 3D environment into parameters for a crop, trim, or filter command for the video data; and
applying the command with the parameters to the video data;
wherein the presenting the produced XR video to the user via a display of the XR headset includes presenting the video data resulting from the applied command.

5. The method of claim 1, wherein:
the at least one virtual element is a virtual background;
the first user input indicates an existing background in the video data; and
the augmenting the video data includes replacing the existing background with the virtual background.

6. The method of claim 6, wherein the augmenting the video data further includes applying parallax to the virtual background based on the depth data.

7. The method of claim 1, wherein the at least one virtual element includes a virtual sticker, an emoji, a picture, a video, or any combination thereof.

8. The method of claim 1, wherein the causing the produced XR video to be sent to the other device associated with the other user includes sharing the produced XR video via an integration with a social media application or a messaging application.

9. The method of claim 1, wherein:
the first user input indicates an existing physical object depicted in the video data; and
the augmenting the video data includes applying an object replacement AI model that replaces the physical object depicted in the video with the at least one virtual element.

10. The method of claim 9, wherein the object replacement AI model identifies the physical object, scales a size of the at least one virtual element based on a size of the identified physical object, and places the scaled at least one virtual element in the produced XR video based on a location of the identified physical object.

11. The method of claim 1, wherein the augmenting the video data includes:
applying a segmenter, to the video data and based on the depth data, wherein the segmenter segments the video data into multiple mattes, each matte associated with a depth value; and
applying a splitter, to the video data and based on the multiple mattes, wherein the splitter (i) identifies a plurality of physical objects in the video data, and (ii) splits the plurality of mattes into background mattes and foreground mattes.

12. A computer-readable storage medium storing instructions, for creating a produced extended-reality (XR) video at an XR headset, the instructions, when executed by a computing system, cause the computing system to:
receive video data from a camera of the XR headset, the video data showing a point-of-view of the user;
receive depth data indicating a distance between the user and at least one object in the video data;
receive a first user input, at the XR headset and/or an input device communicatively coupled to the XR headset, that indicates a user intent to augment the video data with at least one virtual element at a user-selected position within a scene of the video data;
based on the first user input and the depth data, augment the video data by locating the at least one virtual element at the user-selected position to create the produced XR video; and
present the produced XR video to the user via a display of the XR headset.

13. The computer-readable storage medium of claim 12, wherein the depth data is generated by an artificial reality model trained to produce depth data for image data received by the artificial reality model.

14. The computer-readable storage medium of claim 12, wherein the instructions, when executed, further cause the computing system to:
receive a second user input, as motion in a 3D environment, that indicates a user intent to crop a video that the video data represents, trim the video that the video data represents, apply a filter to the video that the video data represents, or any combination thereof;
translate the motion in the 3D environment into parameters for a crop, trim, or filter command for the video data; and
apply the command with the parameters to the video data;
wherein the presenting the produced XR video to the user via a display of the XR headset includes presenting the video data resulting from the applied command.

15. The computer-readable storage medium of claim 12, wherein:
the at least one virtual element is a virtual background;
the first user input indicates an existing background in the video data; and
the augmenting the video data includes replacing the existing background with the virtual background.

16. The computer-readable storage medium of claim 15, wherein the augmenting the video data further includes applying parallax to the virtual background based on the depth data.

17. The computer-readable storage medium of claim 12, wherein the at least one virtual element includes a virtual sticker, an emoji, a picture, a video, or any combination thereof.

18. The computer-readable storage medium of claim 12, wherein the depth data is from a depth sensor of the XR headset.

19. A computing system for creating a produced extended-reality (XR) video at an XR headset, the computing system comprising:
one or more processors; and
one or more memories storing instructions that, when executed by the one or more processors, cause the computing system to:
receive video data from a camera of the XR headset, the video data showing a point-of-view of the user;
receive depth data indicating a distance between the user and at least one object in the video data;
receive a first user input, at the XR headset and/or an input device communicatively coupled to the XR headset, that indicates a user intent to augment the video data with at least one virtual element at a user-selected position within a scene of the video data;
based on the first user input and the depth data, augment the video data by locating the at least one virtual element at the user-selected position to create the produced XR video; and
provide, from the XR headset, the produced XR video.

20. The computing system of claim 19, wherein:
the first user input indicates an existing physical object depicted in the video data;
the augmenting the video data includes applying an object replacement AI model that replaces the physical object depicted in the video with the at least one virtual element; and
the object replacement AI model identifies the physical object, scales a size of the at least one virtual element based on a size of the identified physical object, and places the scaled at least one virtual element in the produced XR video based on a location of the identified physical object.
